(19) United States
(12) Patent Application Publication
(10) Pub. No.: US 2019/0320411 A1
(43) Pub. Date: Oct. 17, 2019

(54) MANAGING PAGING OF A WIRELESS DEVICE

(71) Applicant: Telefonaktiebolaget LM Ericsson (publ), Stockholm (SE)

(72) Inventors: Raimundas GAIGALAS, Hässelby (SE); Tomas BRÄNNLUND, Sigtuna (SE); Jonas NILSSON, Ljungsbro (SE)

(21) Appl. No.: 16/310,816

(22) PCT Filed: Jul. 14, 2016
(86) PCT No.: PCT/SE2016/050713

§ 371 Date: Dec. 17, 2018

(51) Int. Cl. H04W 68/00; H04W 76/18; H04W 48/18; H04W 76/11; H04W 8/08

(52) U.S. Cl. CPC H04W 68/005; H04W 76/18; H04W 8/08; H04W 76/11; H04W 48/18

(57) ABSTRACT

A method for managing paging of a wireless device. The method is performed in a radio resource manager and comprises: receiving a paging request from a core network node, the paging request comprising an identifier of a wireless device to be paged; transmitting a paging message in at least one radio cell associated with the radio resource manager; receiving a connection request from a wireless device matching the identifier; determining that the connection request is to be rejected; transmitting a connection reject message to the wireless device matching the identifier; and transmitting a denied message to the core network node, the denied message indicating that a connection request from the wireless device has been rejected.

### TECHNICAL FIELD

The invention relates to radio resource managers, core network nodes, methods, computer programs and computer program products for managing paging of a wireless device.

### BACKGROUND

In cellular networks, paging occurs when the network needs to get in contact with a wireless device, such as a mobile phone. The paging is originated by the core network, e.g. by a Mobility Management Entity (MME), which commands one or more radio base stations to page a particular wireless device by transmitting a paging message. When the wireless device detects the paging message directed to it, the wireless device connects to the network and is able to receive and transmit data.

With internet of things emerging, the number of devices will greatly increase. This will also increase paging traffic in cellular networks. Any reduction of traffic for paging would be of significant benefit. In particular, reduction of traffic for paging when capacity is short would be greatly beneficial

### SUMMARY

It is an object to reduce the traffic due to paging a wireless device.

According to a first aspect, it is presented a method for managing paging of a wireless device. The method is performed in a radio resource manager and comprises the steps of: receiving a paging request from a core network node, the paging request comprising an identifier of a wireless device to be paged; transmitting a paging message in at least one radio cell associated with the radio resource manager; receiving a connection request from a wireless device matching the identifier; determining that the connection request is to be rejected; transmitting a connection reject message to the wireless device matching the identifier; and transmitting a denied message to the core network node, the denied message indicating that a connection request from the wireless device has been rejected.

The denied message may comprise an indicator of the radio cell of the wireless device.

The connection reject message may comprise a wait time indicating how long the wireless device should refrain from transmitting another connection request. In such a case, the denied message also comprises the wait time.

In the transmitting a denied message step, the destination of the core network node may be identified from the identifier of the wireless device.

The step of transmitting a paging message may be performed regardless of current capacity usage in each one of the at least one radio cell.

In the step of determining that the connection request is to be rejected, the determining may be based on a capacity shortage.

According to a second aspect, it is presented a radio resource manager for managing paging of a wireless device. The radio resource manager comprises: a processor; and a memory storing instructions that, when executed by the processor, causes the radio resource manager to: receive a paging request from a core network node, the paging request comprising an identifier of a wireless device to be paged; transmit a paging message in at least one radio cell associated with the radio resource manager; receive a connection request from a wireless device matching the identifier; determine that the connection request is to be rejected; transmit a connection reject message to the wireless device matching the identifier; and transmit a denied message to the core network node, the denied message indicating that a connection request from the wireless device has been rejected.

The denied message may comprise an indicator of the radio cell of the wireless device.

The connection reject message may comprise a wait time indicating how long the wireless device should refrain from transmitting another connection request. In such a case, the denied message also comprises the wait time.

The instructions to transmit a denied message may comprise instructions that, when executed by the processor, causes the radio resource manager to identify the destination of the core network node from the identifier of the wireless device.

The radio resource manager may further comprise instructions that, when executed by the processor, causes the radio resource manager to perform the instructions to transmit a paging message regardless of current capacity usage in each one of the at least one radio cell.

The instructions to determine that the connection request is to be rejected may comprise instructions that, when executed by the processor, causes the radio resource manager to perform the determining based on a capacity shortage.

According to a third aspect, it is presented a radio resource manager comprising: means for receiving a paging request from a core network node, the paging request comprising an identifier of a wireless device to be paged; means for transmitting a paging message in at least one radio cell associated with the radio resource manager; means for receiving a connection request from a wireless device matching the identifier; means for determining that the connection request is to be rejected; means for transmitting a connection reject message to the wireless device matching the identifier; and means for transmitting a denied message to the core network node, the denied message indicating that a connection request from the wireless device has been rejected.

According to a fourth aspect, it is presented a computer program for a radio resource manager. The computer program comprises computer program code which, when run on a radio resource manager causes the radio resource manager to: receive a paging request from a core network node, the paging request comprising an identifier of a wireless device to be paged; transmit a paging message in at least one radio cell associated with the radio resource manager; receive a connection request from a wireless device matching the identifier; determine that the connection request is to be rejected; transmit a connection reject message to the wireless device matching the identifier; and transmit a denied message to the core network node, the denied message indicating that a connection request from the wireless device has been rejected.

According to a fifth aspect, it is presented a computer program product comprising a computer program according to the fourth and a computer readable means on which the computer program is stored.

According to a sixth aspect, it is presented a method for managing paging of a wireless device. The method is performed in a core network node and comprises the steps of: transmitting a paging request to a radio resource manager, the paging request comprising an identifier of a wireless device to be paged; and receiving a denied message from the radio resource manager, the denied message indicating that a connection request from the wireless device has been rejected by the radio resource manager.

The denied message may comprise a wait time indicating how long the wireless device should refrain from transmitting another connection request.

The core network node may refrain from transmitting a new paging request for the wireless device until a time period corresponding to the wait time has passed.

The core network node may refrain from transmitting paging requests for the wireless device to other radio resource managers after receiving the denied message.

According to a seventh aspect, it is presented a core network node for managing paging of a wireless device. The core network node comprises: a processor; and a memory storing instructions that, when executed by the processor, causes the core network node to: transmit a paging request to a radio resource manager, the paging request comprising an identifier of a wireless device to be paged; and receive a denied message from the radio resource manager, the denied message indicating that a connection request from the wireless device has been rejected by the radio resource manager.

The denied message may comprise a wait time indicating how long the wireless device should refrain from transmitting another connection request.

The core network node may refrain from transmitting a new paging request for the wireless device until a time period corresponding to the wait time has passed.

The core network node may refrain from transmitting paging requests for the wireless device to other radio resource managers after receiving the denied message.

The core network node may be a mobility management entity.

According to an eighth aspect, it is presented a core network node comprising: means for transmitting a paging request to a radio resource manager, the paging request comprising an identifier of a wireless device to be paged; and means for receiving a denied message from the radio resource manager, the denied message indicating that a connection request from the wireless device has been rejected by the radio resource manager.

According to a ninth aspect, it is presented a computer program for managing paging of a wireless device. The computer program comprises computer program code which, when run on a core network node causes the core network node to: transmit a paging request to a radio resource manager, the paging request comprising an identifier of a wireless device to be paged; and receive a denied message from the radio resource manager, the denied message indicating that a connection request from the wireless device has been rejected by the radio resource manager.

According to a tenth aspect, it is presented a computer program product comprising a computer program according to the ninth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a cellular communication network where embodiments presented herein may be applied;

FIG. 2 is a schematic diagram illustrating a possible radio cell layout which can be applied using the system of FIG. 1;

FIG. 3 is a sequence diagram illustrating communication between various entities of embodiments which can be applied in the environment of FIG. 1;

FIG. 4 is a flow chart illustrating embodiments of methods for managing paging of a wireless device performed in a radio resource manager;

FIGS. 5A-B are flow charts illustrating embodiments of methods for managing paging of a wireless device performed in a core network node;

FIG. 6 is a schematic diagram illustrating components of the radio resource manager of FIG. 1 according to one embodiment;

FIG. 7 is a schematic diagram illustrating components of the core network node of FIG. 1 according to one embodiment;

FIG. 8 is a schematic diagram showing functional modules of the radio resource manager of FIG. 1 according to one embodiment;

FIG. 9 is a schematic diagram showing functional modules of the core network device of FIG. 1 according to one embodiment; and

FIG. 10 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Embodiments presented herein are applied in a paging scenario. A radio resource manager is requested by a core network node to page a wireless device. When a resulting connection request from the wireless device is rejected by the radio resource manager, this information is provided also to the core network node. In this way, the core network node learns that the wireless device is in one of the cells of the radio resource manager, even though the wireless device is not allowed to establish a connection. Hence, there is no reason for the core network node to widen the paging to other radio resource managers, effectively avoiding page explosion, i.e. expanded traffic due to the paging area having to be increased.

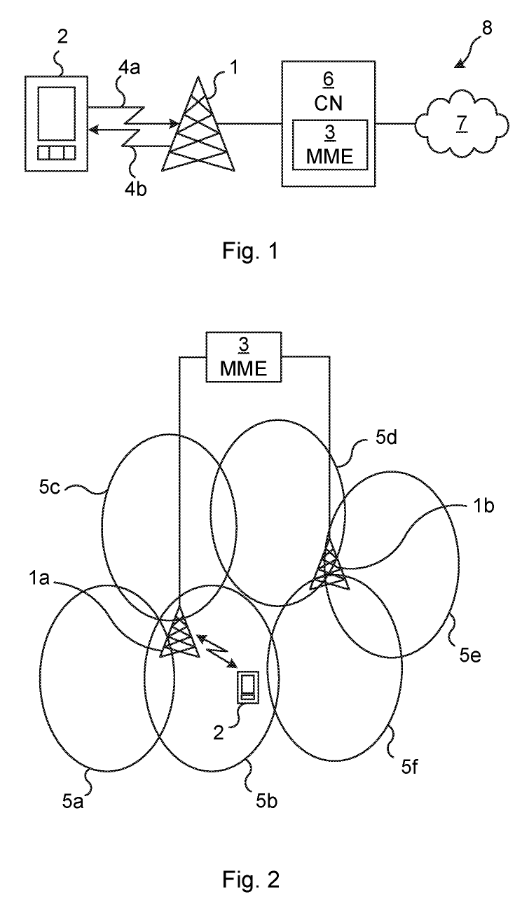

FIG. 1 is a schematic diagram illustrating a cellular communication network 8 where embodiments presented herein may be applied. The cellular communication network 8 comprises a core network 6 and one or more radio resource managers 1, here in the form of radio base stations being evolved Node Bs, also known as eNode Bs or eNBs. The radio resource manager 1 could also be in the form of Node Bs, BTSs (Base Transceiver Stations) and/or BSSs (Base Station Subsystems), etc. The radio resource manager 1 provides radio connectivity over a wireless interface 4a-b to a plurality of wireless devices 2. It is to be noted that the radio resource manager 1 can be provided in a single device or be split in different sections in different locations. For instance, a radio section of the radio resource manager can be located in radio cell locations relatively close to antennas for radio communication to and from the wireless devices 2. Additionally, a cloud section can be located elsewhere, e.g. in the core network 6 or in another cloud processing centre. The cloud section can perform processing which does not need to be in the immediate vicinity of the radio cell. In all embodiments herein, there is no restriction with regard to whether the radio resource manager 1 is provided in a single device in a single location or as a split device in multiple locations.

The term wireless device is also known as mobile communication terminal, user equipment (UE), mobile terminal, user terminal, user agent, wireless terminal, machine-to-machine device etc., and can be, for example, what today are commonly known as a mobile phone, smart phone or a tablet/laptop with wireless connectivity. The term wireless is here to be construed as having the ability to perform wireless communication. More specifically, the wireless device 2 can comprise a number of wires for internal and/or external purposes.

The cellular communication network 8 may e.g. comply with any one or a combination of LTE (Long Term Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, as long as the principles described hereinafter are applicable.

Over the wireless interface, uplink (UL) communication 4a occurs from the wireless device 2 to the radio resource manager 1 and downlink (DL) communication 4b occurs from the radio resource manager 1 to the wireless device 2. The quality of the wireless radio interface to each wireless device 2 can vary over time and depending on the position of the wireless device 2, due to effects such as fading, multipath propagation, interference, etc.

The radio resource manager 1 is also connected to the core network 6 for connectivity to central functions and a wide area network 7, such as the Internet.

The core network 6 comprises, i.a. a Mobility Management Entity (MME) 3. The MME 3 is a core network node which provides functions related to connection management and bearer management.

In order not to obscure the concepts presented herein, other core network nodes are omitted from the cellular communication network 8 of FIG. 1, but may be used as needed during operation.

FIG. 2 is a schematic diagram illustrating a possible radio cell layout which can be applied using the system of FIG. 1.

In this example, there is a first radio resource manager 1a and a second radio resource manager 1b. The first radio resource manager 1a is associated with three radio cells 5a-c. The second radio resource manager 1b, in turn, is associated with three other radio cells 5d-f.

A wireless device 2 is currently located in a second radio cell 5b, associated with the first radio resource manager 1a. Hence, if the first radio resource manager 1a pages the wireless device 2 in at least the second radio cell 5b, the wireless device 2 responds with a connection request (as explained in more detail below). In this way, the first radio resource manager 1a can deduce that the wireless device is located somewhere within the radio cell(s) that are paged.

If the first radio resource manager 1 pages in all of its three radio cells 5a-c, the location of the wireless device 2 can be determined to be somewhere in any one of these radio cells 5a-c. On the other hand, if the first radio resource manager 1 pages only in the second radio cell 5b, the location of the wireless device 2 is determined to be in the second radio cells 5b. However, paging cell by cell can take longer, so there is a balance between paging accuracy and paging time.

It is to be noted that the scenario in FIG. 2 is only an example. There may be more radio resource managers and each radio resource manager can be associated with one, two, three or more radio cells.

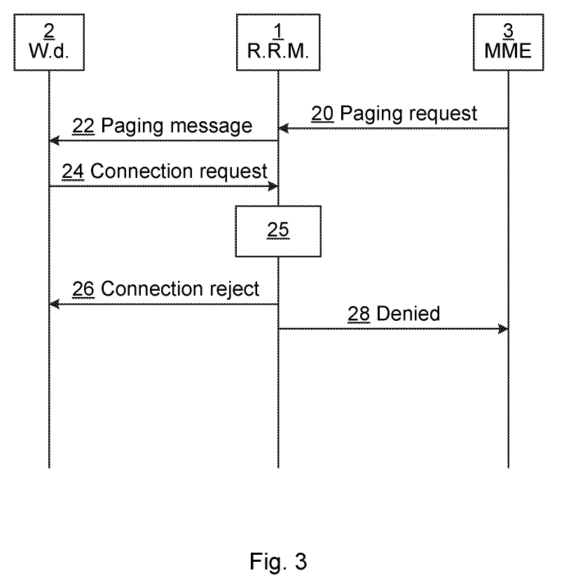

FIG. 3 is a sequence diagram illustrating communication between various entities of embodiments which can be applied in the environment of FIG. 1.

The MME 3 determines that the wireless device needs to be paged, e.g. due to incoming (downlink) traffic for the wireless device. The MME 3 thus transmits a paging request 20 to a radio resource manager 1. The paging request can e.g. be an S1-AP PAGING message. The selection of what radio resource manager(s) 1 to send the paging request 20 to can be performed in accordance with what is known in the art per se.

Once the radio resource manager 1 receives the paging request 20, it transmits a paging message 22 in one or more of its radio cells, i.e. one or more radio cells associated with the radio resource manager 1. The paging message 22 comprises an identifier of the wireless device 2 which is paged.

The wireless device 2 receives the paging message 22 and determines that the wireless device identifier in the paging message 22 matches the wireless device. The next action is the wireless device 2 transmitting a connection request 24 to the radio resource manager 1. The connection request can e.g. be an RRC (Radio Resource Control) connection request, which can comprise a parameter EstablishmentCause=mt−Access, used when a connection is requested due to paging. Alternatively, the connection request can be an RRC resume request if the wireless device is in a suspended state.

Once the connection request 24 is received, the radio resource manager 1 determines 25 that the connection request 24 should be rejected, e.g. due to lack of capacity. Hence, the radio resource manager 1 transmits a connection reject message 26 to the wireless device 2. The connection reject message 26 can be an RRC connection reject message. Alternatively, the connection request can be an RRC resume reject if the wireless device is in a suspended state.

Additionally, the radio resource manager 1 transmits a denied message 28 to the MME. In this way, the MME 3 can deduce that the wireless device is located in a radio cell associated with the radio resource manager 1, but there is no connection established with the wireless device 2.

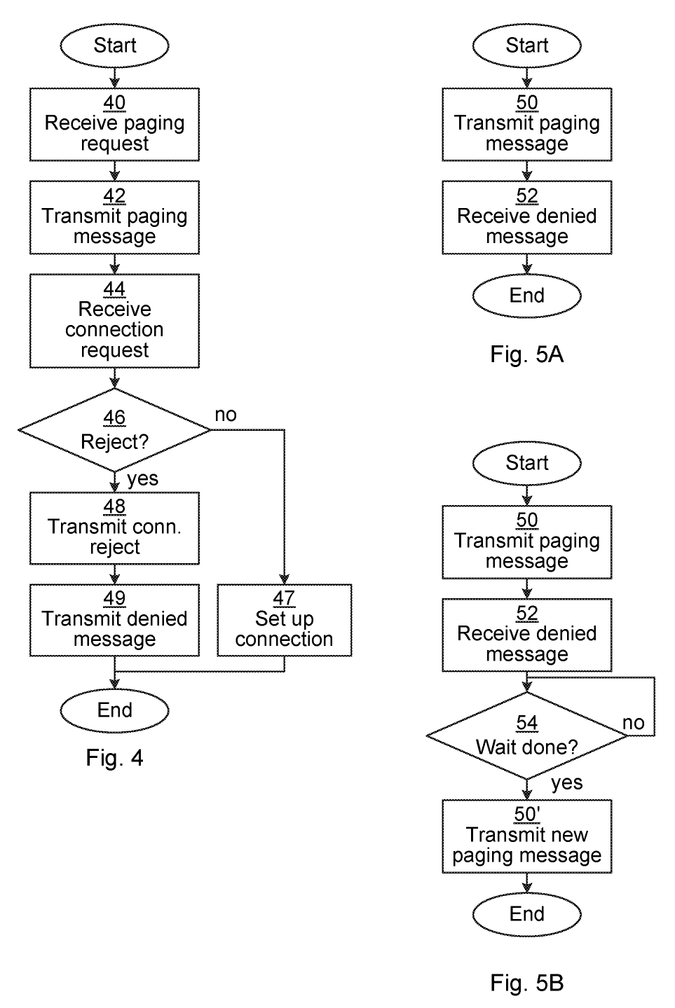

FIG. 4 is a flow chart illustrating embodiments of methods for managing paging of a wireless device performed in a radio resource manager, e.g. as shown in FIG. 1. The steps of the method at least partly correspond to the activities of the radio resource manager 1 of the sequence diagram of FIG. 3. In line with what is explained above, the method can be performed in a radio resource manager 1 provided as a single device in a single location. However, the method could equally well be performed in a distributed radio resource manager, e.g. with a radio section and a cloud section being provided in different locations. It is to be noted that any reception and transmission mentioned here does not imply that the signal/message needs to be directly received or transmitted from the other communication entity. In other words, there may be intermediate entities (e.g. the radio section for a step performed in the cloud section) provided between the transmitter/receiver and the other communication entity.

In a receive paging request step 40, a paging request 20 is received from a core network node 3. The paging request 20 comprises an identifier of a wireless device 2 to be paged. The identifier can e.g. be an S-TMSI (System Architecture Evolution-Temporary Mobile Subscriber Identity). It is to be noted that paging requests can be transmitted from the core network node 3 to multiple radio resource managers in parallel. However, this method is from the perspective of a single radio resource manager and this processing does not need to be any different when multiple radio resource managers are used for the paging initiated by the core network node.

In a transmit paging message step 42, a paging message 22 is transmitted in at least one radio cell associated with the radio resource manager 1. The paging message 22 comprises an identifier of the wireless device 2 which is paged. The identifier is obtained from the paging request 20. This step can be performed regardless of current capacity usage in each one of the at least one radio cell. In this way, it can be determined whether the wireless device is located in the at least one radio cell, even if it will not be allowed to establish a connection.

In a receive connection request step 44, a connection request 24 is received from a wireless device 2 matching the identifier.

In a conditional reject step 46, the radio resource manager determines whether the connection request 24 is to be rejected. This determination can e.g. be based on a capacity shortage, protocol errors, predicted future high priority traffic, etc. Capacity can here relate to radio resource capacity, processing capacity, memory capacity etc. If the connection request is to be rejected, the method continues to a transmit connection reject step 48. Otherwise, the method continues to a set up connection step 47.

In a transmit connection reject step 48, a connection reject message 26 is transmitted to the wireless device matching the identifier. Optionally, the connection reject message 26 comprises a wait time indicating how long the wireless device 2 should refrain from transmitting another connection request.

In a transmit denied message step 49, a denied message 28 is transmitted to the core network node 3. The denied message 28 indicates that a connection request 24 from the wireless device has been rejected. The denied message comprises an indicator of the radio resource manager. Optionally, the denied message 28 also comprises an indicator of the radio cell of the wireless device. Optionally, the denied message 28 also comprises the wait time, if this was transmitted to the wireless device 2 in the connection reject message 26.

The destination of the core network node 3 is optionally identified from the identifier of the wireless device 2. For instance, an MME code can be extracted from an S-TMSI forming part of the paging request 20 received in step 40. The MME-code is thus used to identify the destination of the core network node 3.

In the set up connection step 47, a connection with the wireless device 2 is established as known in the art per se.

Using embodiments presented herein, the core network node 3 learns that the wireless device is in one of the cells of the radio resource manager, even though the wireless device is not allowed to establish a connection. Hence, there is no reason for the core network node 3 to widen the paging to other radio resource managers, effectively avoiding page explosion, i.e. expanded traffic due to the paging area having to be increased. Since this situation is more likely to occur in situations where capacity is scarce, the benefit of the reduced paging traffic is greatly increased. Nevertheless, the reason for the rejection is not critical; page explosion is avoided regardless of the reason for rejecting the connection request.

The embodiments presented herein may be particularly beneficial for devices in an Internet of things (IoT) scenario. Firstly, IoT devices may be considered to be delay tolerant, increasing the likelihood of the radio resource manager rejecting connection requests from such wireless devices. Secondly, targeted paging areas (fewer radio cells) may be more common for IoT, i.e. the paging is started in a smaller group of radio cells and then expands the paging area if there is no response to the paging. Thirdly, the use of wait times, which can have values up to 30 minutes, might be more common.

FIGS. 5A-B are flow charts illustrating embodiments of methods for managing paging of a wireless device performed in a core network node. The method is started when the core network node determines that the wireless device needs to be paged, e.g. due to incoming (downlink) traffic for the wireless device.

In a transmit paging message step 50, a paging request 20 is transmitted to a radio resource manager 1. The paging request 20 comprises an identifier of a wireless device 2 to be paged.

In a receive denied message step 52, a denied message 28 is received from the radio resource manager 1. The denied message 28 indicates that a connection request 24 from the wireless device has been rejected by the radio resource manager 1. The denied message comprises an indicator of the radio resource manager. Optionally, the denied message 28 also comprises an indicator of the radio cell of the wireless device. Hence, the core network node learns the location of the wireless device. This location can be used as a starting point for later paging requests for the wireless device. As a result of receiving the denied message, the core network node refrains from transmitting paging requests for the wireless device to other radio resource managers, to avoid a paging explosion.

Optionally, as explained above, the denied message 28 can comprise a wait time indicating how long the wireless device 2 should refrain from transmitting another connection request.

Looking now to FIG. 5B, only new or modified steps compared to the method of FIG. 5A will be described.

In a conditional wait done step 54, it is determined whether a time period corresponding to the wait time has passed since step 52 was performed. If the time period has passed, the method proceeds to a transmit new paging message step 50′.

In the transmit new paging message step 50′, the core network node transmits a new paging request for the wireless device, if this is found useful. It is to be noted that this step could also be omitted if the core network node no longer has a need to page the wireless device.

The core network node 3 thus waits at least the wait time until it sends any new paging message after receiving the denied message.

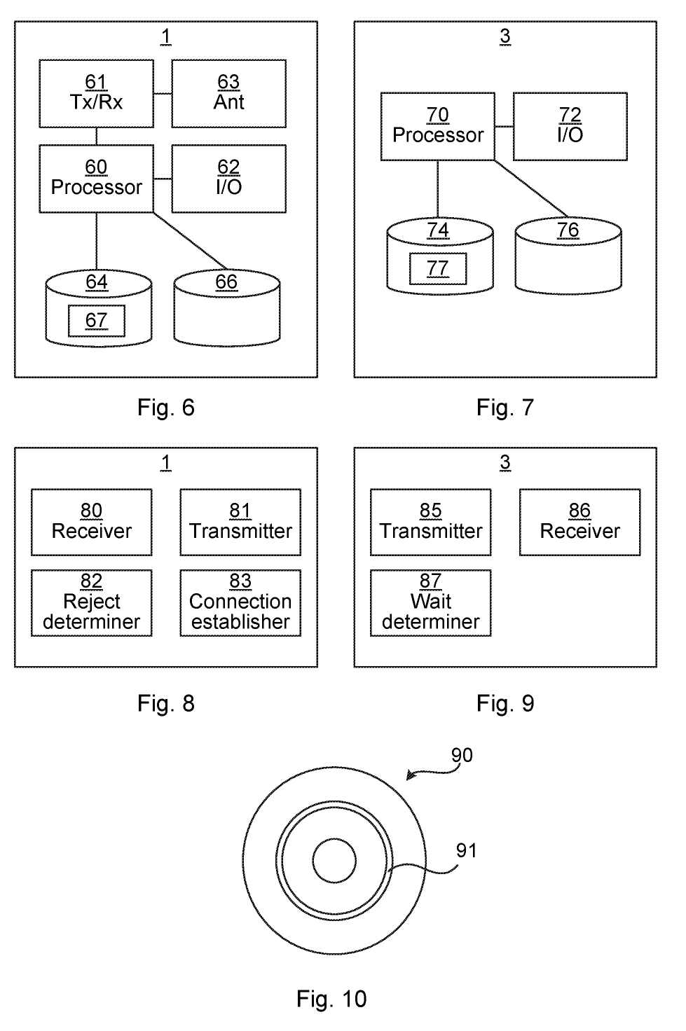

FIG. 6 is a schematic diagram illustrating components of the radio resource manager 1 of FIG. 1 according to one embodiment. As explained above, the radio resource manager 1 can be provided in one device or it can be split in multiple devices over multiple sites.

A processor 60 is provided using any combination of one or more of a suitable central processing unit (CPU), multiprocessor, microcontroller, digital signal processor (DSP), application specific integrated circuit etc., capable of executing software instructions 67 stored in a memory 64, which can thus be a computer program product. The processor 60 can be configured to execute the method described with reference to FIG. 4 above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 66 is also provided for reading and/or storing data during execution of software instructions in the processor 6o. The data memory 66 can be any combination of read and write memory (RAM) and read only memory (ROM).

The radio resource manager 1 further comprises an I/O interface 62 for communicating with other external entities. Optionally, the I/O interface 62 also includes a user interface.

An optional transceiver 61 comprises suitable analogue and digital components to allow signal transmission and signal reception with a wireless device using one or more antennas 63.

Other components of the radio resource manager 1 are omitted in order not to obscure the concepts presented herein.

FIG. 7 is a schematic diagram illustrating components of the core network node 3 of FIG. 1 according to one embodiment. A processor 70 is provided using any combination of one or more of a suitable central processing unit (CPU), multiprocessor, microcontroller, digital signal processor (DSP), application specific integrated circuit etc., capable of executing software instructions 77 stored in a memory 74, which can thus be a computer program product. The processor 70 can be configured to execute the method described with reference to FIGS. 5A-B above.

The memory 74 can be any combination of read and write memory (RAM) and read only memory (ROM). The memory 74 also comprises persistent storage, which, for example, can be any single one or combination of magnetic memory, optical memory, solid state memory or even remotely mounted memory.

A data memory 76 is also provided for reading and/or storing data during execution of software instructions in the processor 70. The data memory 76 can be any combination of read and write memory (RAM) and read only memory (ROM).

The core network node 3 further comprises an I/O interface 72 for communicating with other external entities. Optionally, the I/O interface 72 also includes a user interface.

Other components of the core network node 3 are omitted in order not to obscure the concepts presented herein.

FIG. 8 is a schematic diagram showing functional modules of the radio resource manager of FIG. 1 according to one embodiment. The modules are implemented using software instructions such as a computer program executing in the radio resource manager. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIG. 4.

A receiver 80o corresponds to steps 40 and 44. A transmitter 81 corresponds to steps 42, 48 and 49. A reject determiner 82 corresponds to step 46. A connection establisher 83 corresponds to step 47.

FIG. 9 is a schematic diagram showing functional modules of the core network device of FIG. 1 according to one embodiment. The modules are implemented using software instructions such as a computer program executing in the core network node. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 5A and 5B.

A transmitter 85 corresponds to steps 50 and 50′. A receiver 86 corresponds to step 52. A wait determiner 87 corresponds to step 54.

FIG. 10 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program products 64, 74 of FIGS. 6 and 7. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1. A method for managing paging of a wireless device, the method being performed in a radio resource manager, comprising:
receiving a paging request from a core network node, the paging request comprising an identifier of a wireless device to be paged;
transmitting a paging message in at least one radio cell associated with the radio resource manager;
receiving a connection request from a wireless device matching the identifier;
determining that the connection request is to be rejected;
transmitting a connection reject message to the wireless device matching the identifier; and
transmitting a denied message to the core network node, the denied message indicating that the connection request from the wireless device has been rejected.

2. The method according to claim 1, wherein the denied message comprises an indicator of a radio cell of the wireless device.

3. The method according to claim 1, wherein the connection reject message comprises a wait time indicating how long the wireless device should refrain from transmitting another connection request; and wherein the denied message also comprises the wait time.

4. The method according to claim 1, wherein, in the transmitting the denied message, a destination of the core network node is identified from the identifier of the wireless device.

5. The method according to claim 1, wherein the transmitting the paging message is performed regardless of current capacity usage in each one of the at least one radio cell.

6. The method according to claim 1, wherein in the determining that the connection request is to be rejected, the determining is based on a capacity shortage.

7. A radio resource manager for managing paging of a wireless device, the radio resource manager comprising:
a processor; and
a memory storing instructions that, when executed by the processor, cause the radio resource manager to:
receive a paging request from a core network node, the paging request comprising an identifier of a wireless device to be paged;
transmit a paging message in at least one radio cell associated with the radio resource manager;
receive a connection request from a wireless device matching the identifier;
determine that the connection request is to be rejected;
transmit a connection reject message to the wireless device matching the identifier; and
transmit a denied message to the core network node, the denied message indicating that the connection request from the wireless device has been rejected.

8. The radio resource manager according to claim 7, wherein the denied message comprises an indicator of a radio cell of the wireless device.

9. The radio resource manager according to claim 7, wherein the connection reject message wireless device should refrain from transmitting another connection request; and wherein the denied message also comprises the wait time.

10. The radio resource manager according to claim 7, wherein, the instructions to transmit a denied message cause the radio resource manager to identify a destination of the core network node from the identifier of the wireless device.

11. The radio resource manager according to claim 7, further comprising instructions that, cause the radio resource manager to transmit a paging message regardless of current capacity usage in each one of the at least one radio cell.

12. The radio resource manager according to claim 7, wherein the instructions to determine that the connection request is to be rejected further cause the radio resource manager determine based on a capacity shortage.

13-15. (canceled)

16. A method for managing paging of a wireless device, the method being performed in a core network node and comprising:
transmitting a paging request to a radio resource manager, the paging request comprising an identifier of a wireless device to be paged; and
receiving a denied message from the radio resource manager, the denied message indicating that a connection request from the wireless device has been rejected by the radio resource manager.

17. The method according to claim 16, wherein the denied message comprises a wait time indicating how long the wireless device should refrain from transmitting another connection request.

18. The method according to claim 17, wherein the core network node refrains from transmitting a new paging request for the wireless device until a time period corresponding to the wait time has passed.

19. The method according to claim 16, wherein the core network node refrains from transmitting paging requests for the wireless device to other radio resource managers after receiving the denied message.

20. A core network node for managing paging of a wireless device, the core network node comprising:
a processor; and
a memory storing instructions that, when executed by the processor, cause the core network node to:
transmit a paging request to a radio resource manager, the paging request comprising an identifier of a wireless device to be paged; and
receive a denied message from the radio resource manager, the denied message indicating that a connection request from the wireless device has been rejected by the radio resource manager.

21. The core network node according to claim 20, wherein the denied message comprises a wait time indicating how long the wireless device should refrain from transmitting another connection request.

22. The core network node according to claim 21, wherein the core network node refrains from transmitting a new paging request for the wireless device until a time period corresponding to the wait time has passed.

23. The core network node according to claim 20, wherein the core network node refrains from transmitting paging requests for the wireless device to other radio resource managers after receiving the denied message.

24-27. (canceled)
